(19) United States
(12) Patent Application Publication
(10) Pub. No.: US 2008/0184610 A1
(43) Pub. Date: Aug. 7, 2008

(54) Method and apparatus for aerial deployment of waterfowl decoys

(76) Inventor: J. Trask Pfeifle, Darien, CT (US)

Correspondence Address: ABELMAN, FRAYNE & SCHWAB, 666 THIRD AVENUE, 10TH FLOOR, NEW YORK, NY, 10017, US

(21) Appl. No.: 11/703,403

(22) Filed: Feb. 6, 2007

(51) Int. Cl. A01M 31/06

(52) U.S. Cl. 43/3

(57) ABSTRACT

A method and apparatus for deploying a plurality of aerial decoys that extend away from the ground at different elevations includes launching a kite to a position downwind of the desired observation or hunting zone and attaching aerodynamic bird decoys at a plurality of spaced-apart locations along the ascending kite string to simulate a number of birds approaching the landing zone. The decoys are preferably attached to the kite string through a swivel device and the tethered end of the kite string can be supported above a mast or stake that is securely positioned in the ground or bottom of the body of water on to which the birds are to be attracted. The entire assembly is conveniently provided in kit form that is both manually transportable and can be put into use by one individual.

### FIELD OF THE INVENTION

This invention relates to the deployment of aerial decoys for the purpose of attracting waterfowl flying over water or open fields.

### BACKGROUND OF THE INVENTION

The use of decoys to attract over-flying waterfowl to induce them to land in water or open fields have been in use for centuries. Various forms of aerially deployed decoys, some of which give the appearance of low-flying waterfowl and/or waterfowl that appear to be in a descending state in preparation for landing on water or open fields have been developed. For example, U.S. Pat. Nos. 3,436,856 and 6,357,160 propose the use of inflatable aerial decoys that are filled with a lighter-than-air gas, e.g., helium, and their attachment at intervals to a tethered length of string. The deployed array of gas-filled decoys would presumably prove attractive to over-flying waterfowl. However, this proposal does not provide an entirely satisfactory or practical solution to the aerial deployment problem. The initial cost of manufacturing an inflatable decoy will clearly be substantially greater than that of producing other types of aerial decoys from sheet material, since the inflatable portion must be produced from a material that is both lightweight and also relatively impermeable to the small helium molecules that provide the lifting force. As is known to even average observers, a helium-filled balloon soon loses its lighter-than-air characteristic due to the migration of the pressurized helium molecules through the balloon's material.

Inflated decoys are also subject to damage from stray birdshot, where even the smallest puncture or tear will result in deflation which may be sufficient to bring the entire string down, or render it so unnatural in appearance as to lose its capability to attract waterfowl to the landing site.

The means for achieving the angular displacement of the inflated decoys to give the appearance of a flight of waterfowl at different heights as would be seen during a natural ascent is not apparent. It would be expected that the tethering line would extend substantially vertically, since the inflated decoys will rise upwardly when released.

Another significant logistical problem is securing a source of helium and the expense to the user. The use of inflated decoys also raises a significant question concerning their transportation and storage during the hunt. It would obviously be most convenient for the hunter to inflate the decoys at the hunting site; however, this means that the hunter would also have to transport the pressurized helium container to and from the site.

In the alternative, the decoys may be inflated at a location where the pressurized helium tank is stored, e.g., the hunter's home, but consideration must then be given to transporting the inflated decoys to the general vicinity of the hunt (typically in a motor vehicle) and then on foot from the vehicle to the site where the retaining line will be tethered. Protection of the decoys from damage during transportation raises other logistic considerations. It is entirely foreseeable that one or more of the inflated decoys may be damaged during shooting and/or transportation to and from the site of their disposition. The hunter is then faced with the alternative of providing additional inflated replacement decoys or packing the helium container and a repair kit to the hunting site.

As will be understood from the above considerations, an improved apparatus and method for aerially deploying a plurality of decoys that simulate a group of waterfowl ascending to a landing site are needed.

It is therefore one object of the present invention to provide such a method and apparatus that is both reliable and durable and that does not require the use of pressurized lighter-than-air gasses to maintain the aerial decoys aloft.

It is another object of the present invention to provide a method and apparatus which can be both transported and put to use by a single hunter in order to deploy a plurality of aerial decoys at different altitudes to thereby attract over-flying waterfowl to a landing site.

It is yet another object of this invention to provide a kit of components that can be arranged in a compact manner in a carrying case transportable by an individual of average strength and then rapidly assembled without special tools or equipment to aerially deploy a plurality of decoys.

Another object of the invention is to provide a method and apparatus for deploying a number of aerial decoys that are rugged and will resist failure if they are hit by bird shot and/or suffer minor tears and/or punctures during the foreseeable conditions of use in the field and transportation.

### SUMMARY OF THE INVENTION

The method and apparatus of the invention deploys aerial decoys for use in observing, photographing and hunting birds and specifically waterfowl, including geese and ducks, in open fields and over water. The method includes the steps of deploying a kite of known design and lift capacity that assumes a relatively stable position in flight (as compared to a so-called stunt kite). The kite string is provided with a number of spaced-apart points of attachment such as fittings, to which are attached a plurality of aerial decoys. The tethered end of the kite string is preferably supported on an attached stationary mast above the surface of the ground or water to avoid contact with personnel or interference by other objects at ground level.

Kites of appropriate design can be launched in relatively light winds, e.g., four miles per hour. The kite structure is provided with a number of strings and means for adjustment that enable the user to adjust the angle of the kite string relative to the surface of the ground or water, and thereby to control the height above the surface at which the kite will assume a generally stable position during the hunt. The attached waterfowl decoys are deployed from the supporting kite string at heights of between 100 and 200 feet above the ground.

The means for attachment of the aerial decoys preferably includes a swivel device that will permit the attached decoys to rotate around the axis of the string without becoming twisted or wrapped around the kite string, thereby shortening the lead line of the decoy. Suitable devices include barrel swivels of the type used in mounting fishing gear to fishing lines.

The points of attachment for the aerial decoys along the kite string can vary from between fifteen and twenty feet, more or less. The decoys can be attached with a short lead comprising clips and swivels of the type used in mounting fishing gear, or by braided or monofilament lines of suitable strength. In one preferred embodiment, three aerial decoys are attached to the string at intervals of about fifteen feet to give the appearance of three birds descending to the surface for landing.

To facilitate the deployment and the recovery of the aerial decoys and kite, the kite string is conveniently attached to a conventional fishing reel which in turn can be releasably attached to the stationary supporting mast during storage and use. As the kite is suspended in flight following launching, the reel controls the dispensing of line to permit the user to attach the aerial decoys at the desired positions along the kite string. When it comes time for recovery of the aerial decoy system, the line is manually reeled in and the decoys can be detached as they come within reach of the mast.

The aerial decoys are preferably of the type that maintain a relatively stable orientation and are assembled with removable struts, much like a kite. This permits the decoys to be deconstructed and reduced in size for transportation and storage in a compact kit.

The design and construction of the mast is not critical. In a preferred embodiment, the mast and its ground support are constructed as a kit to enable the user to conveniently store, transport and install the mast at the hunting location. A base unit includes a ground-penetrating tubular spike of suitable length to penetrate the soil in the area of the hunt. The spike can range from twelve to twenty-four inches in length and is preferably hollow to receive the mast and minimize its weight. A cross-member is provided at the upper end of the spike for placement of the user's foot to aid in pushing the spike into the ground; the open end of the spike extends above the cross-member to permit the spike to be driven with a maul or other suitable implement, if necessary. The spike can also be provided with one or more laterally projecting blades that serve to stabilize the spike in loose soil or sand, and to resist any forces transmitted by the kite that might tend to dislodge the mast.

The projecting upper portion of the spike receives one end of the mast, which is preferably either telescoping or constructed of two or more interlocking tubular components to facilitate storage, packing and transportation to the hunting site. Depending upon wind and ground conditions, two or more guy wires with suitable means of attachment at the upper portion of the mast can be provided to further stabilize the mast against the lateral force of the kite. A retainer, such as a pulley, swivel eye, snap ring, open loop, or other suitable device to slidably receive the kite string, is affixed to the top of the mast. The kite string can be positioned in the retainer at the top of the mast prior to attachment to the kite's control lines. The kite string can be stored on a winding device, such as a fishing reel, and the reel can be detachably secured to a section of the mast in the same manner a fishing reel is attached to a fishing rod.

The particular design and configuration of the aerial decoys is not critical to the present invention. A wide variety of commercially available aerial decoys can be utilized in the practice of the method and apparatus. However, as discussed above, inflated decoys may suffer damage in the field from stray bird shot, present logistical problems and are therefore not preferred for use in this invention. Especially suitable decoys are those made from synthetic materials in the form of flexible sheets that can be printed with colors and patterns and that have been shown to be attractive to specific types of game birds. Particularly useful commercial products are those manufactured from polymeric sheet material which is waterproof, has a very high resistance to tearing and can maintain its structure and utility if struck by some stray bird shot. A suitable sheet material is sold under the TYVEK® trademark.

Once the kite and decoys have been deployed, the observers or hunting party assumes appropriate positions along the flight path of the incoming game birds.

### BRIEF DESCRIPTIONS OF THE DRAWINGS

The invention will be further described below and with reference to the attached drawings in which like and similar elements are referred to by the same number, and in which:

FIG. 1 is one embodiment of the aerial deployment of decoys in accordance with the invention;

FIG. 2 is a second embodiment of the invention;

FIG. 3 is one embodiment of a swivel attachment for use with the invention; and

FIG. 4 is one embodiment of a mounting spike for use with the invention.

### DETAILED DESCRIPTION OF THE PREFERRED EMBODIMENT

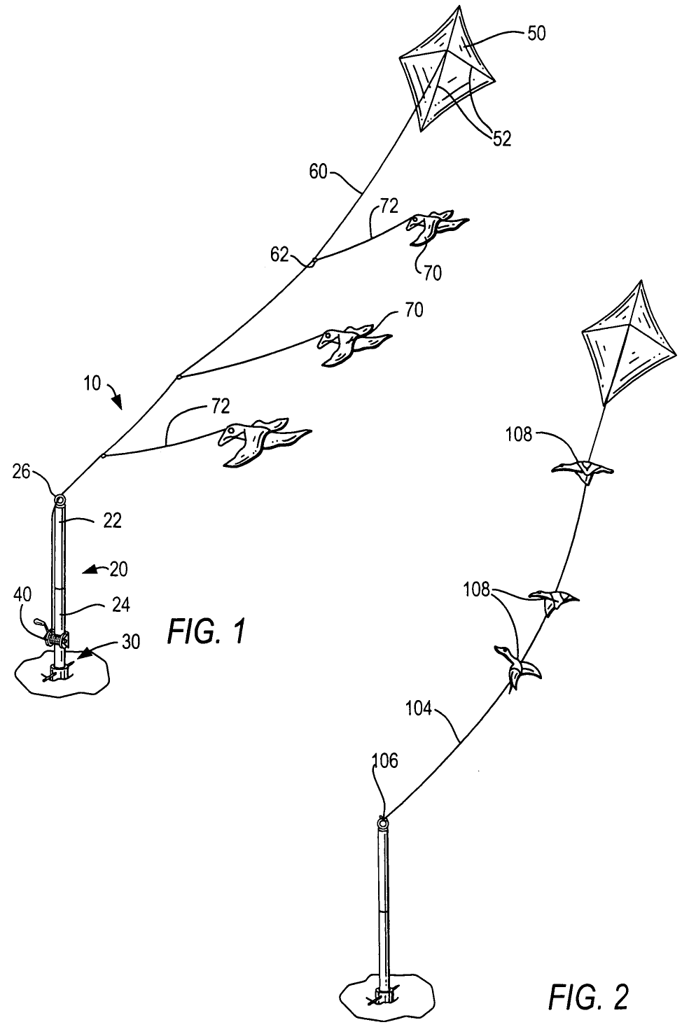

Referring to FIG. 1, one embodiment of the apparatus of the invention (10) is depicted in position on open ground. In this embodiment, mast (20) is preferably constructed of two interlocking or telescoping elements (22,24). A retainer loop (26) is provided at the upper portion of mast (20) to slidingly receive the kite string. The lower end of the mast is securely received in ground spike (30), which will be described in greater detail below. A reel (40) for storing and deploying kite string (60) is removeably attached to a section of the mast. It will be understood that the apparatus of the invention does not require a reel or spool for retaining and storing the kite string. The kite string can be wrapped in a roll or ball or on other conventional retaining devices and played out as the kite is launched in a conventional manner. The free end of the string can then be secured to the mast, or other stationary device, such as a fence post or ground stake. As noted above, the attachment of the free end of the kite string at a position above the heads of the hunters will avoid interference and promote safer use of the equipment.

In a particularly preferred embodiment, the color and to the extent possible, the size of the lifting or supporting kite will be the same as the species of the bird that is to be attracted. For example, when Canada Geese are being hunted or photographed, the kite will be black and of a size that approximates the extended wing span of this species. A white kite will be used with Snow Geese and when ducks are to be attracted, the dimensions of the kite will be smaller and will be colored to represent, e.g., a mallard duck. As will be apparent, birds other than water fowl can be attracted by the apparatus and method of the invention. For example, crow hunters will employ a relatively smaller black kite; a white or light-colored kite can also be used to support white-wing dove decoys. Other refinements can also be made to the design and markings of the support kite in order to provide an attractive appearance to waterfowl and birds.

With continuing reference to FIG. 1, kite (50) is provided with adjustable control lines (52) that are conventionally used to control the altitude of the kite in flight. Kite string (60) is provided with loops (62) or other fittings for securing the aerial decoys (70). In the preferred embodiment shown, a single decoy is connected at each point on the line (60); however, two or more aerial decoys (70), for example, can be attached by decoy tether lines (72) of different length at a single position on string (60). In this regard, FIG. 2 illustrates an embodiment in which the aerial decoys (70) are attached to string (60) with short or no decoy tether lines. In this embodiment, the decoys are also attached by a swivel.

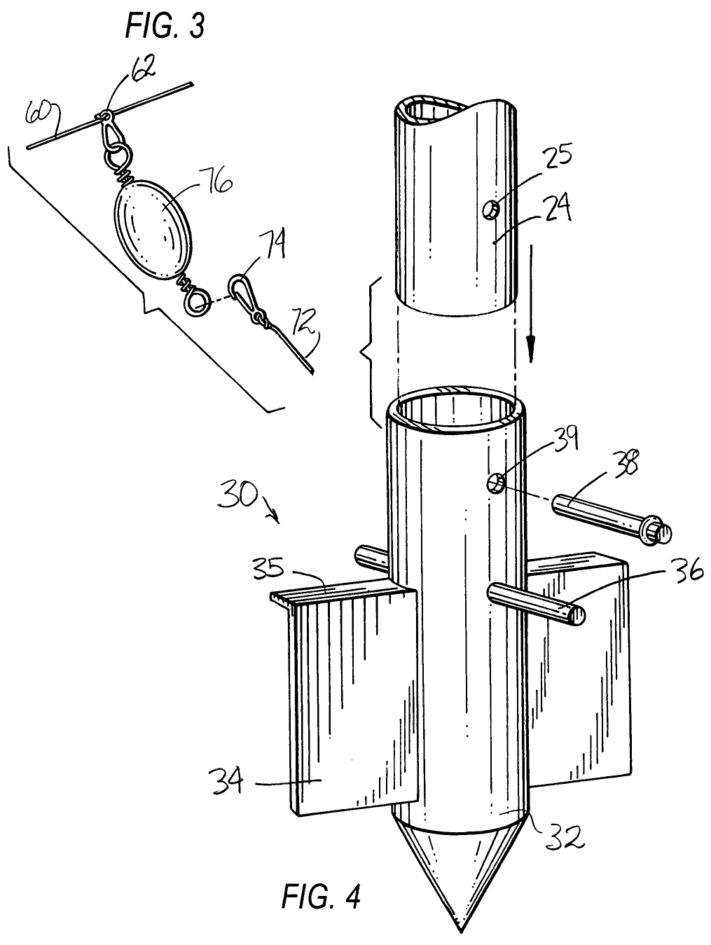

Referring now to FIG. 3, a section of the kite string (60) is shown at a point of attachment (62) which includes a small loop fitting to which is attached a barrel swivel (76). The tether line (72) which leads to a decoy is provided with a snap clip for ease of attachment to the barrel swivel (76). It is to be understood that a simple loop can be tied directly in the kite string (60) to provide a point of attachment and that one or more barrel swivels or other functionally equivalent devices can be placed at any position in the series of fittings that is convenient for the user. Having in mind that the apparatus will be subjected to use in the field, non-corrosive swivels and other fittings made from brass, stainless steel or the like are preferred and that multiple redundant swivels can be included in the event of damage due to exposure to dirt and the like.

With reference to FIG. 4, there is illustrated one embodiment of a ground-penetrating spike (32) formed from a length of pipe of a diameter that is suitable for receiving the lower end of mast (24) in close-fitting relation. In this embodiment, the ground spike is provided with projecting blades (34) which serve to stabilize the mast against external forces and provide a more secure placement in soft ground, e.g., when the apparatus is used in a water environment. As shown, blade (34) also includes a generally horizontal flange for inserting the spike with the bottom of a boot or shoe. Additionally, a transverse rod (36) is also positioned to provide for placement of a boot or shoe on either side. An optional transverse locking pin (38) can be provided to pass through opening (39) and correspondingly positioned opening (25) in the lower mask section (24) in order to secure the mast to the ground spike.

In the practice of the method of the invention, kite (50) is launched using string (60) and one or more aerial decoys (70) are attached to the string at spaced-apart locations are also launched as the kite rises above the ground. When the desired number of decoys is in position, the free end of string (60) is secured to a fixed location. In the preferred embodiment as described above, the reel (40) attached to mast (20) is locked in position and string (60) is maintained well above ground level to avoid interference with personnel, dogs, boats or other objects moving around in the vicinity of the kite string and mast. The points of attachment of the plurality of decoys are selected to present the appearance of a flight of waterfowl in a landing attitude, and this for the purpose of attracting overflying waterfowl to the observation or hunting site.

While several illustrative examples and embodiments of the method and apparatus of the invention have been described, other modifications and variations will be apparent to those of ordinary skill in the art, and the scope of the invention and its protection is to be determined with respect to the claims that follow.

I claim:

1. An apparatus for the aerial deployment of a plurality of airborne bird decoys comprising:
a kite,
a length of kite string, and
a plurality of aerodynamic bird decoys attached at predetermined intervals to the kite string,
whereby the plurality of decoys appear to be in a descending flight array along the kite string when the kite is aloft.

2. The apparatus of claim 1 in which the decoys are secured to the kite string by a tethering line, whereby the airborne decoys have a degree of movement that is free of contact with the kite string.

3. The apparatus of claim 1 which includes a mounting swivel between the kite string and each of the decoys.

4. The apparatus of claim 1 which includes at least one release clip for detachably mounting each decoy to the kite string.

5. The apparatus of claim 1 in which the kite string includes permanent points of attachment for the decoys at predetermined intervals along its length.

6. The apparatus of claim 5 in which the points of attachment are selected from loops tied in the string, and clips and swivel devices secured to the string.

7. The apparatus of claim 1 in which the decoys are attached to the kite string at intervals of about fifteen feet.

8. The apparatus of claim 1 which includes a mounting mast for retaining the free end of the kite string above ground level.

9. The apparatus of claim 8 in which the mast includes a top guide for the kite string and a string-retaining device removably mounted on the mast.

10. A method for the aerial deployment of a plurality of bird decoys, the method comprising:
a. deploying a kite in the air from a depending kite string in the vicinity of a desired bird landing zone;
b. securing a plurality of individual aerial bird decoys at spaced-apart intervals along the length of kite string; and
c. securing the free end of the kite string in order to maintain the kite in an airborne condition and the decoys deployed at differing heights above the ground in proximity to the landing zone.

11. The method of claim 10 in which the decoys are secured to the kite string through a swivel device.

12. The method of claim 10 in which each of the plurality of decoys is joined to the kite string by a tethering line.

13. The method of claim 10 which includes providing the kite string with a plurality of spaced-apart permanent points of attachment between the kite and the free end for securing the decoys.

14. The method of claim 13 in which each of the points of attachment include at least one swivel device, whereby the kite string is isolated from rotational movement of the aerial decoys during use.

15. The method of claim 10 in which each decoy is deployed at the end of a tethering line and the tethering line is releasably clipped to the kite string at a single point of attachment.

16. The method of claim 10 which includes the further steps of:
d. securely positioning a mast in the ground in the desired landing zone;
e. mounting a kite string reel on the mast; and
f. securing the free end of the kite string to the reel.

17. The method of claim 16 which includes the further step of passing the kite string through a guide that slidably receives the string at a position on the upper portion of the mast above the ground.

18. A manually portable kit for use in attracting birds in flight to a landing zone, the kit comprising:
a. a plurality of aerial bird decoys constructed from flexible sheet material and assembled with reinforcing struts to provide an aerodynamic structure;
b. a kite assembly that includes a flexible kite sheet and reinforcing struts, the kite having sufficient lift to maintain a predetermined plurality of the aerial bird decoys aloft in use; and
c. a kite string for flying the kite and securing the plurality of the decoys at spaced-apart points of attachment along the string to produce the appearance of a flight of birds approaching the landing zone.

19. The kit of claim 18 which includes a sectional mounting mast, the mast having a ground penetrating spike for insertion into a supporting surface, at least one kite string guide at the upper portion of the mast for slidably receiving the kite string, and retaining means for releasably receiving a kite string storage device.

20. The kit of claim 19 which includes a mechanical reel for retaining and securing the free end of the kite string, the reel being removably mountable on the mast.
